(19) United States
(12) Patent Application Publication
(10) Pub. No.: US 2024/0150255 A1
(43) Pub. Date: May 9, 2024

(54) ORGANO-MINERAL SOIL AMENDMENT USING ROCK FINES

(71) Applicant: Specialty Granules Investments LLC, Parsippany, NJ (US)

(72) Inventors: Raju Khatiwada, Hagerstown, MD (US); Peter Wilson, Knoxville, MD (US); Jason Clark, Frederick, MD (US)

(21) Appl. No.: 18/498,837

(22) Filed: Oct. 31, 2023

Related U.S. Application Data
(60) Provisional application No. 63/423,122, filed on Nov. 7, 2022.

(51) Int. Cl. C05G 3/80

(52) U.S. Cl. CPC C05G 3/80

(57) ABSTRACT

A composition that includes (a) at least one of basalt, metabasalt, diabase, andesite, meta-andesite, phyllite, rhyolite, or a combination thereof, with the at least one of basalt, metabasalt, diabase, andesite, meta-andesite, phyllite, rhyolite, or a combination thereof being present at 30 wt % to 70 wt % based on a total weight of the composition, (b) an organic portion that is present at 20 wt % to 65 wt % based on the total weight of the composition, and (c) a binder. The composition is in the form of a plurality of particles. The composition can find applications in agriculture, horticulture, and gardening, and can be used, e.g., as soil amendment.

This application claims the priority of U.S. provisional application Ser. No. U.S. 63/423,122 entitled “Organo-Mineral Soil Amendment Using Rock Fines” filed Nov. 7, 2022, which is incorporated herein by reference in its entirety for all purposes.

### FIELD OF THE INVENTION

The invention relates to rock fines for use in agricultural, horticultural, or gardening applications such as a soil amendment comprising an organo-mineral composition. The invention further relates to methods of making such soil amendments.

### BACKGROUND OF THE INVENTION

The increasing demand for food supply to feed the growing population has led people to look into alternative fertilizer sources. There is thus a need for sustainable alternative materials that could serve as a fertilizer and/or a soil amendment besides commercial synthetic fertilizers.

### SUMMARY OF THE INVENTION

One embodiment of this invention pertains to a soil amendment composition comprising: at least one of basalt, metabasalt, diabase, andesite, meta-andesite, phyllite, rhyolite, or a combination thereof, wherein the at least one of basalt, metabasalt, diabase, andesite, meta-andesite, phyllite, rhyolite, or a combination thereof is present at 30 wt % to 70 wt % based on a total weight of the soil amendment composition; an organic portion that is present at 20 wt % to 65 wt % based on the total weight of the soil amendment composition; and a binder, wherein the soil amendment composition is in the form of a plurality of particles.

In one embodiment, the soil amendment composition comprises basalt.

In one embodiment, the soil amendment composition comprises metabasalt.

In one embodiment, the organic portion comprises at least one of coffee chaff, rice husk, animal manure, turkey/poultry litter, animal bedding, food derived waste, agricultural waste, saw dust, wood chips, peat moss, coconut coir, bagasse, compost, biochar, sewage sludge, blood meal, bone meal, fish meal, feather meal, corn steep dry, soy protein hydrolysates, coffee grinds, food or animal derived digestate, or a combination thereof.

In one embodiment, the organic portion comprises coffee chaff, food derived waste, or a combination thereof.

In one embodiment, the organic portion is present at 30 wt % to 65 wt % based on the total weight of the soil amendment composition. In one embodiment, the organic portion is present at 40 wt % to 65 wt % based on the total weight of the soil amendment composition.

In one embodiment, the binder is present at 0.5 wt % to 20 wt % based on the total weight of the soil amendment composition. In one embodiment, the binder is present at 0.5 wt % to 15 wt % based on the total weight of the soil amendment composition. In one embodiment, the binder is present at 0.5 wt % to 10 wt % based on the total weight of the soil amendment composition. In another embodiment, the binder is present at 2 wt % to 5 wt % based on the total weight of the soil amendment composition.

In one embodiment, the binder is molasses, lignosulfonate, clay (such as, e.g., bentonite clay), or a combination thereof.

In one embodiment, the soil amendment composition further comprises humic acid. In one embodiment, the humic acid is present at 0.5 wt % to 25 wt % based on the total weight of the soil amendment composition. In another embodiment, the humic acid is present at 0.5 wt % to 5 wt % based on the total weight of the soil amendment composition.

In one embodiment, the soil amendment composition is substantially free of a microbial component.

In one embodiment, the at least one of basalt, metabasalt, diabase, andesite, meta-andesite, phyllite, rhyolite, or a combination thereof is in the form of a plurality of particles (referred herein as “rock fines”), with at least about 60% of the rock fines passing 100 US Mesh. In another embodiment, at least about 60% of the rock fines pass 100 US Mesh and the balance pass 200 US Mesh.

In one embodiment, the at least one of basalt, metabasalt, diabase, andesite, meta-andesite, phyllite, rhyolite, or a combination thereof is in the form of a plurality of particles (referred herein as “rock fines”) that are of such a particle size as to pass US Mesh 40. In other embodiments, the rock fines are of such a particle size as to pass US Mesh 50, or US Mesh 60, or US Mesh 70, or US Mesh 100, or US Mesh 120, or US Mesh 140, or US Mesh 200, or US Mesh 230, or US Mesh 270, or US Mesh 325.

In one embodiment, the plurality of particles have an average particle size of about 0.25 mm to about 10 mm. In another embodiment, the plurality of particles have an average particle size of about 1 mm to about 4 mm. In another embodiment, the plurality of particles have an average particle size about 2 mm to about 3 mm.

Another embodiment of this invention pertains to a method comprising: (a) mixing (i) at least one of basalt, metabasalt, diabase, andesite, meta-andesite, phyllite, rhyolite, or a combination thereof, (ii) an organic portion, and (iii) a binder to produce a plurality of particles; (b) heating the plurality of particles; and (c) separating particles from the plurality of particles in accordance with size to obtain a soil amendment composition, wherein the at least one of basalt, metabasalt, diabase, andesite, meta-andesite, phyllite, rhyolite, or a combination thereof is present at 30 wt % to 70 wt % based on a total weight of the soil amendment composition, and wherein the organic portion is present at 20 wt % to 65 wt % based on the total weight of the soil amendment composition.

In one embodiment, the mixing uses a pin mixer.

In one embodiment, the method further comprises pelletizing the soil amendment composition. In another embodiment, the pelletizing uses at least one of a disk pelletizer or a pan pelletizer.

In one embodiment, the heating includes exposing the plurality of particles to a temperature of 38° C. to 150° C.

In one embodiment, the organic portion comprises at least one of coffee chaff, rice husk, animal manure, turkey/poultry litter, animal bedding, food derived waste, agricultural waste, saw dust, wood chips, peat moss, coconut coir, bagasse, compost, biochar, sewage sludge, blood meal, bone meal, fish meal, feather meal, corn steep dry, soy protein hydrolysates, coffee grinds, food or animal derived digestate, or a combination thereof.

In one embodiment, the organic portion comprises coffee chaff, food derived waste, or a combination thereof.

In one embodiment, the organic portion is present at 30 wt % to 65 wt % based on the total weight of the soil amendment composition. In one embodiment, the organic portion is present at 40 wt % to 65 wt % based on the total weight of the soil amendment composition.

In one embodiment, the binder is present at 0.5 wt % to 20 wt % based on the total weight of the soil amendment composition. In one embodiment, the binder is present at 0.5 wt % to 15 wt % based on the total weight of the soil amendment composition. In one embodiment, the binder is present at 0.5 wt % to 10 wt % based on the total weight of the soil amendment composition. In another embodiment, the binder is present at 2 wt % to 5 wt % based on the total weight of the soil amendment composition.

In one embodiment, the binder is molasses, lignosulfonate, clay (such as, e.g., bentonite clay), or a combination thereof.

In one embodiment, the mixing further includes mixing humic acid with (i) the at least one of basalt, metabasalt, diabase, andesite, meta-andesite, phyllite, rhyolite, or a combination thereof, (ii) the organic portion, and (iii) the binder to produce a plurality of particles.

In one embodiment, the humic acid is present at 0.5 wt % to 25 wt % based on the total weight of the soil amendment composition. In another embodiment, the humic acid is present at 0.5 wt % to 5 wt % based on the total weight of the soil amendment composition.

In one embodiment, the at least one of basalt, metabasalt, diabase, andesite, meta-andesite, phyllite, rhyolite, or a combination thereof is in the form of a plurality of particles (referred herein as “rock fines”), with at least about 60% of the rock fines passing 100 US Mesh. In another embodiment, at least about 60% of the rock fines pass 100 US Mesh and the balance pass 200 US Mesh.

In one embodiment, the at least one of basalt, metabasalt, diabase, andesite, meta-andesite, phyllite, rhyolite, or a combination thereof is in the form of a plurality of particles (referred herein as “rock fines”) that are of such a particle size as to pass US Mesh 40. In other embodiments, the rock fines are of such a particle size as to pass US Mesh 50, or US Mesh 60, or US Mesh 70, or US Mesh 100, or US Mesh 120, or US Mesh 140, or US Mesh 200, or US Mesh 230, or US Mesh 270, or US Mesh 325.

In one embodiment, the plurality of particles have an average particle size of about 0.25 mm to about 10 mm. In another embodiment, the plurality of particles have an average particle size of about 1 mm to about 4 mm. In another embodiment, the plurality of particles have an average particle size about 2 mm to about 3 mm.

### DETAILED DESCRIPTION OF THE INVENTION

Among those benefits and improvements that have been disclosed, other objects and advantages of this disclosure will become apparent from the following description. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising,” “including,” and “having” do not limit the scope of a specific claim to the materials or steps recited by the claim.

As used herein, terms such as “consisting of and “composed of limit the scope of a specific claim to the materials and steps recited by the claim.

All prior patents, publications, and test methods referenced herein are incorporated by reference in their entireties.

As used herein, the term “wt %” or “weight percent” or “% by weight” means the percentage by weight of (i) the organic portion based upon a total weight of the soil amendment composition, (ii) the binder based upon a total weight of the soil amendment composition, or (iii) humic acid based upon a total weight of the soil amendment composition.

As used herein, all ranges are inclusive of endpoints unless otherwise specified.

As used herein, “between” when referring to a range shall include both mentioned endpoints (for example, “between 1 wt % and 15 wt %” shall include both 1 wt % and 15 wt %), unless otherwise specified.

The terms “substantially”, “approximately,” and “about” used throughout this Specification and the claims generally mean plus or minus 10% of the value stated, e.g., about 100 would include 90 to 110. Thus, as used herein, the term “about X” means X plus or minus 10%. For example, “about 10 wt %” means 9 wt % to 11 wt %.

As used herein, the term “binder” refers to a compound that can bind a plurality of rock fines (e.g., basalt particles) together. The “binder” can either be liquid or solid.

The present disclosure relates to an organo-mineral fertilizer or soil amendment. The organo-mineral fertilizer or soil amendment comprises bulk rock fines, which are rich in plant essential nutrients/minerals, such as, e.g., basalt, metabasalt, diabase, andesite, meta-andesite, phyllite, rhyolite, or a combination thereof, that are added to plant and/or animal derived organic material, such as, e.g., coffee chaff, food waste, or animal derived manure, which is then pelletized/compacted with binders, such as, e.g., molasses, to obtain granules. These granules or finished product serve as a fertilizer or soil amendment that can be either applied as a bulk mix (including, e.g., a potting mix and/or a turf mix) or in pelletized form.

According to one embodiment, the mineral portion of the organo-mineral fertilizer or soil amendment is supplied by rock fines from a mining industry. In one embodiment, the rock fines or rock types include at least one of basalt, metabasalt, diabase, andesite, meta-andesite, phyllite, rhyolite, or a combination thereof.

According to one embodiment, the organic portion of the organo-mineral fertilizer or soil amendment is supplied by coffee chaff, rice husk, animal manure, turkey/poultry litter, animal bedding, food derived waste, agricultural waste, saw dust, wood chips, peat moss, coconut coir, bagasse, compost, biochar, sewage sludge, blood meal, bone meal, fish meal, feather meal, corn steep dry, soy protein hydrolysates, coffee grinds, food or animal derived digestate, or a combination thereof. In some cases, these organic materials are dried and/or composted to derive a mineral/ash fraction and blended together with rock fines to make the final product (e.g., the soil amendment).

One embodiment of this invention pertains a soil amendment composition comprising: at least one of basalt, metabasalt, diabase, andesite, meta-andesite, phyllite, rhyolite, or a combination thereof, wherein the at least one of basalt, metabasalt, diabase, andesite, meta-andesite, phyllite, rhyolite, or a combination thereof is present at 30 wt % to 70 wt % based on a total weight of the soil amendment composition; an organic portion that is present at 20 wt % to 65 wt % based on the total weight of the soil amendment composition; and a binder, wherein the soil amendment composition is in the form of a plurality of particles.

In one embodiment, the soil amendment composition comprises basalt. In one embodiment, the soil amendment composition comprises metabasalt.

In one embodiment, the organic portion comprises at least one of coffee chaff, rice husk, animal manure, turkey/poultry litter, animal bedding, food derived waste, agricultural waste, saw dust, wood chips, peat moss, coconut coir, bagasse, compost, biochar, sewage sludge, blood meal, bone meal, fish meal, feather meal, corn steep dry, soy protein hydrolysates, coffee grinds, food or animal derived digestate, or a combination thereof. In one embodiment, the organic portion comprises coffee chaff, food derived waste, or a combination thereof.

In one embodiment, the at least one of basalt, metabasalt, diabase, andesite, meta-andesite, phyllite, rhyolite, or a combination thereof is present at 40 wt % to 70 wt % based on the total weight of the soil amendment composition. In one embodiment, the at least one of basalt, metabasalt, diabase, andesite, meta-andesite, phyllite, rhyolite, or a combination thereof is present at 50 wt % to 70 wt % based on the total weight of the soil amendment composition. In one embodiment, the at least one of basalt, metabasalt, diabase, andesite, meta-andesite, phyllite, rhyolite, or a combination thereof is present at 60 wt % to 70 wt % based on the total weight of the soil amendment composition. In one embodiment, the at least one of basalt, metabasalt, diabase, andesite, meta-andesite, phyllite, rhyolite, or a combination thereof is present at 30 wt % to 60 wt % based on the total weight of the soil amendment composition. In one embodiment, the at least one of basalt, metabasalt, diabase, andesite, meta-andesite, phyllite, rhyolite, or a combination thereof is present at 40 wt % to 60 wt % based on the total weight of the soil amendment composition. In one embodiment, the at least one of basalt, metabasalt, diabase, andesite, meta-andesite, phyllite, rhyolite, or a combination thereof is present at 50 wt % to 60 wt % based on the total weight of the soil amendment composition. In one embodiment, the at least one of basalt, metabasalt, diabase, andesite, meta-andesite, phyllite, rhyolite, or a combination thereof is present at 30 wt % to 40 wt % based on the total weight of the soil amendment composition. In one embodiment, the at least one of basalt, metabasalt, diabase, andesite, meta-andesite, phyllite, rhyolite, or a combination thereof is present at 30 wt % to 50 wt % based on the total weight of the soil amendment composition. In one embodiment, the at least one of basalt, metabasalt, diabase, andesite, meta-andesite, phyllite, rhyolite, or a combination thereof is present at 40 wt % to 50 wt % based on the total weight of the soil amendment composition.

In one embodiment, the organic portion is present at 25 wt % to 65 wt % based on the total weight of the soil amendment composition. In one embodiment, the organic portion is present at 30 wt % to 65 wt % based on the total weight of the soil amendment composition. In one embodiment, the organic portion is present at 35 wt % to 65 wt % based on the total weight of the soil amendment composition. In one embodiment, the organic portion is present at 40 wt % to 65 wt % based on the total weight of the soil amendment composition. In one embodiment, the organic portion is present at 45 wt % to 65 wt % based on the total weight of the soil amendment composition. In one embodiment, the organic portion is present at 50 wt % to 65 wt % based on the total weight of the soil amendment composition. In one embodiment, the organic portion is present at 55 wt % to 65 wt % based on the total weight of the soil amendment composition. In one embodiment, the organic portion is present at 20 wt % to 55 wt % based on the total weight of the soil amendment composition. In one embodiment, the organic portion is present at 25 wt % to 55 wt % based on the total weight of the soil amendment composition. In one embodiment, the organic portion is present at 30 wt % to 55 wt % based on the total weight of the soil amendment composition. In one embodiment, the organic portion that is present at 35 wt % to 55 wt % based on the total weight of the soil amendment composition. In one embodiment, the organic portion is present at 40 wt % to 55 wt % based on the total weight of the soil amendment composition. In one embodiment, the organic portion is present at 45 wt % to 55 wt % based on the total weight of the soil amendment composition. In one embodiment, the organic portion is present at 50 wt % to 55 wt % based on the total weight of the soil amendment composition. In one embodiment, the organic portion is present at 20 wt % to 50 wt % based on the total weight of the soil amendment composition. In one embodiment, the organic portion is present at 25 wt % to 50 wt % based on the total weight of the soil amendment composition. In one embodiment, the organic portion is present at 30 wt % to 50 wt % based on the total weight of the soil amendment composition. In one embodiment, the organic portion that is present at 35 wt % to 50 wt % based on the total weight of the soil amendment composition. In one embodiment, the organic portion is present at 40 wt % to 50 wt % based on the total weight of the soil amendment composition. In one embodiment, the organic portion is present at 45 wt % to 50 wt % based on the total weight of the soil amendment composition. In one embodiment, the organic portion is present at 20 wt % to 45 wt % based on the total weight of the soil amendment composition. In one embodiment, the organic portion is present at 25 wt % to 45 wt % based on the total weight of the soil amendment composition. In one embodiment, the organic portion is present at 30 wt % to 45 wt % based on the total weight of the soil amendment composition. In one embodiment, the organic portion that is present at 35 wt % to 45 wt % based on the total weight of the soil amendment composition. In one embodiment, the organic portion is present at 40 wt % to 45 wt % based on the total weight of the soil amendment composition. In one embodiment, the organic portion is present at 20 wt % to 40 wt % based on the total weight of the soil amendment composition. In one embodiment, the organic portion is present at 25 wt % to 40 wt % based on the total weight of the soil amendment composition. In one embodiment, the organic portion is present at 30 wt % to 40 wt % based on the total weight of the soil amendment composition. In one embodiment, the organic portion that is present at 35 wt % to 40 wt % based on the total weight of the soil amendment composition. In one embodiment, the organic portion is present at 20 wt % to 35 wt % based on the total weight of the soil amendment composition. In one embodiment, the organic portion is present at 25 wt % to 35 wt % based on the total weight of the soil amendment composition. In one embodiment, the organic portion is present at 30 wt % to 35 wt % based on the total weight of the soil amendment composition. In one embodiment, the organic portion is present at 20 wt % to 30 wt % based on the total weight of the soil amendment composition. In one embodiment, the organic portion is present at 25 wt % to 30 wt % based on the total weight of the soil amendment composition. In one embodiment, the organic portion is present at 20 wt % to 25 wt % based on the total weight of the soil amendment composition.

In one embodiment, the binder is molasses, lignosulfonate, clay (such as, e.g., bentonite clay), or a combination thereof. According to an embodiment, binders like, e.g., molasses acts as a biostimulant.

In one embodiment, the binder is present at 0.5 wt % to 20 wt % based on the total weight of the soil amendment composition. In one embodiment, the binder is present at 1 wt % to 20 wt % based on the total weight of the soil amendment composition. In one embodiment, the binder is present at 2 wt % to 20 wt % based on the total weight of the soil amendment composition. In one embodiment, the binder is present at 3 wt % to 20 wt % based on the total weight of the soil amendment composition. In one embodiment, the binder is present at 4 wt % to 20 wt % based on the total weight of the soil amendment composition. In one embodiment, the binder is present at 5 wt % to 20 wt % based on the total weight of the soil amendment composition. In one embodiment, the binder is present at 6 wt % to 20 wt % based on the total weight of the soil amendment composition. In one embodiment, the binder is present at 7 wt % to 20 wt % based on the total weight of the soil amendment composition. In one embodiment, the binder is present at 8 wt % to 20 wt % based on the total weight of the soil amendment composition. In one embodiment, the binder is present at 9 wt % to 20 wt % based on the total weight of the soil amendment composition. In one embodiment, the binder is present at 10 wt % to 20 wt % based on the total weight of the soil amendment composition. In one embodiment, the binder is present at 11 wt % to 20 wt % based on the total weight of the soil amendment composition. In one embodiment, the binder is present at 12 wt % to 20 wt % based on the total weight of the soil amendment composition. In one embodiment, the binder is present at 13 wt % to 20 wt % based on the total weight of the soil amendment composition. In one embodiment, the binder is present at 14 wt % to 20 wt % based on the total weight of the soil amendment composition. In one embodiment, the binder is present at 15 wt % to 20 wt % based on the total weight of the soil amendment composition. In one embodiment, the binder is present at 16 wt % to 20 wt % based on the total weight of the soil amendment composition. In one embodiment, the binder is present at 17 wt % to 20 wt % based on the total weight of the soil amendment composition. In one embodiment, the binder is present at 18 wt % to 20 wt % based on the total weight of the soil amendment composition. In one embodiment, the binder is present at 19 wt % to 20 wt % based on the total weight of the soil amendment composition. In one embodiment, the binder is present at 0.5 wt % to 15 wt % based on the total weight of the soil amendment composition. In one embodiment, the binder is present at 1 wt % to 15 wt % based on the total weight of the soil amendment composition. In one embodiment, the binder is present at 2 wt % to 15 wt % based on the total weight of the soil amendment composition. In one embodiment, the binder is present at 3 wt % to 15 wt % based on the total weight of the soil amendment composition. In one embodiment, the binder is present at 4 wt % to 15 wt % based on the total weight of the soil amendment composition. In one embodiment, the binder is present at 5 wt % to 15 wt % based on the total weight of the soil amendment composition. In one embodiment, the binder is present at 6 wt % to 15 wt % based on the total weight of the soil amendment composition. In one embodiment, the binder is present at 7 wt % to 15 wt % based on the total weight of the soil amendment composition. In one embodiment, the binder is present at 8 wt % to 15 wt % based on the total weight of the soil amendment composition. In one embodiment, the binder is present at 9 wt % to 15 wt % based on the total weight of the soil amendment composition. In one embodiment, the binder is present at 10 wt % to 15 wt % based on the total weight of the soil amendment composition. In one embodiment, the binder is present at 11 wt % to 15 wt % based on the total weight of the soil amendment composition. In one embodiment, the binder is present at 12 wt % to 15 wt % based on the total weight of the soil amendment composition. In one embodiment, the binder is present at 13 wt % to 15 wt % based on the total weight of the soil amendment composition. In one embodiment, the binder is present at 14 wt % to 15 wt % based on the total weight of the soil amendment composition. In one embodiment, the binder is present at 0.5 wt % to 10 wt % based on the total weight of the soil amendment composition. In one embodiment, the binder is present at 1 wt % to 10 wt % based on the total weight of the soil amendment composition. In one embodiment, the binder is present at 2 wt % to 10 wt % based on the total weight of the soil amendment composition. In one embodiment, the binder is present at 3 wt % to 10 wt % based on the total weight of the soil amendment composition. In one embodiment, the binder is present at 4 wt % to 10 wt % based on the total weight of the soil amendment composition. In one embodiment, the binder is present at 5 wt % to 10 wt % based on the total weight of the soil amendment composition. In one embodiment, the binder is present at 6 wt % to 10 wt % based on the total weight of the soil amendment composition. In one embodiment, the binder is present at 7 wt % to 10 wt % based on the total weight of the soil amendment composition. In one embodiment, the binder is present at 8 wt % to 10 wt % based on the total weight of the soil amendment composition. In one embodiment, the binder is present at 9 wt % to 10 wt % based on the total weight of the soil amendment composition. In one embodiment, the binder is present at 0.5 wt % to 9 wt % based on the total weight of the soil amendment composition. In one embodiment, the binder is present at 1 wt % to 9 wt % based on the total weight of the soil amendment composition. In one embodiment, the binder is present at 2 wt % to 9 wt % based on the total weight of the soil amendment composition. In one embodiment, the binder is present at 3 wt % to 9 wt % based on the total weight of the soil amendment composition. In one embodiment, the binder is present at 4 wt % to 9 wt % based on the total weight of the soil amendment composition. In one embodiment, the binder is present at 5 wt % to 9 wt % based on the total weight of the soil amendment composition. In one embodiment, the binder is present at 6 wt % to 9 wt % based on the total weight of the soil amendment composition. In one embodiment, the binder is present at 7 wt % to 9 wt % based on the total weight of the soil amendment composition. In one embodiment, the binder is present at 8 wt % to 9 wt % based on the total weight of the soil amendment composition. In one embodiment, the binder is present at 0.5 wt % to 8 wt % based on the total weight of the soil amendment composition. In one embodiment, the binder is present at 1 wt % to 8 wt % based on the total weight of the soil amendment composition. In one embodiment, the binder is present at 2 wt % to 8 wt % based on the total weight of the soil amendment composition. In one embodiment, the binder is present at 3 wt % to 8 wt % based on the total weight of the soil amendment composition. In one embodiment, the binder is present at 4 wt % to 8 wt % based on the total weight of the soil amendment composition. In one embodiment, the binder is present at 5 wt % to 8 wt % based on the total weight of the soil amendment composition. In one embodiment, the binder is present at 6 wt % to 8 wt % based on the total weight of the soil amendment composition. In one embodiment, the binder is present at 7 wt % to 8 wt % based on the total weight of the soil amendment. In one embodiment, the binder is present at 0.5 wt % to 7 wt % based on the total weight of the soil amendment composition. In one embodiment, the binder is present at 1 wt % to 7 wt % based on the total weight of the soil amendment composition. In one embodiment, the binder is present at 2 wt % to 7 wt % based on the total weight of the soil amendment composition. In one embodiment, the binder is present at 3 wt % to 7 wt % based on the total weight of the soil amendment composition. In one embodiment, the binder is present at 4 wt % to 7 wt % based on the total weight of the soil amendment composition. In one embodiment, the binder is present at 5 wt % to 7 wt % based on the total weight of the soil amendment composition. In one embodiment, the binder is present at 6 wt % to 7 wt % based on the total weight of the soil amendment composition. In one embodiment, the binder is present at 0.5 wt % to 6 wt % based on the total weight of the soil amendment composition. In one embodiment, the binder is present at 1 wt % to 6 wt % based on the total weight of the soil amendment composition. In one embodiment, the binder is present at 2 wt % to 6 wt % based on the total weight of the soil amendment composition. In one embodiment, the binder is present at 3 wt % to 6 wt % based on the total weight of the soil amendment composition. In one embodiment, the binder is present at 4 wt % to 6 wt % based on the total weight of the soil amendment composition. In one embodiment, the binder is present at 5 wt % to 6 wt % based on the total weight of the soil amendment composition. In one embodiment, the binder is present at 0.5 wt % to 5 wt % based on the total weight of the soil amendment composition. In one embodiment, the binder is present at 1 wt % to 5 wt % based on the total weight of the soil amendment composition. In one embodiment, the binder is present at 2 wt % to 5 wt % based on the total weight of the soil amendment composition. In one embodiment, the binder is present at 3 wt % to 5 wt % based on the total weight of the soil amendment composition. In one embodiment, the binder is present at 4 wt % to 5 wt % based on the total weight of the soil amendment composition. In one embodiment, the binder is present at 0.5 wt % to 4 wt % based on the total weight of the soil amendment composition. In one embodiment, the binder is present at 1 wt % to 4 wt % based on the total weight of the soil amendment composition. In one embodiment, the binder is present at 2 wt % to 4 wt % based on the total weight of the soil amendment composition. In one embodiment, the binder is present at 3 wt % to 4 wt % based on the total weight of the soil amendment composition. In one embodiment, the binder is present at 0.5 wt % to 3 wt % based on the total weight of the soil amendment composition. In one embodiment, the binder is present at 1 wt % to 3 wt % based on the total weight of the soil amendment composition. In one embodiment, the binder is present at 2 wt % to 3 wt % based on the total weight of the soil amendment composition. In one embodiment, the binder is present at 0.5 wt % to 2 wt % based on the total weight of the soil amendment composition. In one embodiment, the binder is present at 1 wt % to 2 wt % based on the total weight of the soil amendment composition. In one embodiment, the binder is present at 0.5 wt % to 1 wt % based on the total weight of the soil amendment composition.

In one embodiment, the soil amendment composition further comprises humic acid. In one embodiment, the humic acid is present at 0.5 wt % to 25 wt % based on the total weight of the soil amendment composition. In one embodiment, the humic acid is present at 1 wt % to 25 wt % based on the total weight of the soil amendment composition. In one embodiment, the humic acid is present at 2 wt % to 25 wt % based on the total weight of the soil amendment composition. In one embodiment, the humic acid is present at 3 wt % to 25 wt % based on the total weight of the soil amendment composition. In one embodiment, the humic acid is present at 4 wt % to 25 wt % based on the total weight of the soil amendment composition. In one embodiment, the humic acid is present at 5 wt % to 25 wt % based on the total weight of the soil amendment composition. In one embodiment, the humic acid is present at 10 wt % to 25 wt % based on the total weight of the soil amendment composition. In one embodiment, the humic acid is present at 15 wt % to 25 wt % based on the total weight of the soil amendment composition. In one embodiment, the humic acid is present at 20 wt % to 25 wt % based on the total weight of the soil amendment composition. In one embodiment, the humic acid is present at 0.5 wt % to 20 wt % based on the total weight of the soil amendment composition. In one embodiment, the humic acid is present at 1 wt % to 20 wt % based on the total weight of the soil amendment composition. In one embodiment, the humic acid is present at 2 wt % to 20 wt % based on the total weight of the soil amendment composition. In one embodiment, the humic acid is present at 3 wt % to 20 wt % based on the total weight of the soil amendment composition. In one embodiment, the humic acid is present at 4 wt % to 20 wt % based on the total weight of the soil amendment composition. In one embodiment, the humic acid is present at 5 wt % to 20 wt % based on the total weight of the soil amendment composition. In one embodiment, the humic acid is present at 10 wt % to 20 wt % based on the total weight of the soil amendment composition. In one embodiment, the humic acid is present at 15 wt % to 20 wt % based on the total weight of the soil amendment composition. In one embodiment, the humic acid is present at 0.5 wt % to 15 wt % based on the total weight of the soil amendment composition. In one embodiment, the humic acid is present at 1 wt % to 15 wt % based on the total weight of the soil amendment composition. In one embodiment, the humic acid is present at 2 wt % to 15 wt % based on the total weight of the soil amendment composition. In one embodiment, the humic acid is present at 3 wt % to 15 wt % based on the total weight of the soil amendment composition. In one embodiment, the humic acid is present at 4 wt % to 15 wt % based on the total weight of the soil amendment composition. In one embodiment, the humic acid is present at 5 wt % to 15 wt % based on the total weight of the soil amendment composition. In one embodiment, the humic acid is present at 10 wt % to 15 wt % based on the total weight of the soil amendment composition. In one embodiment, the humic acid is present at 0.5 wt % to 10 wt % based on the total weight of the soil amendment composition. In one embodiment, the humic acid is present at 1 wt % to 10 wt % based on the total weight of the soil amendment composition. In one embodiment, the humic acid is present at 2 wt % to 10 wt % based on the total weight of the soil amendment composition. In one embodiment, the humic acid is present at 3 wt % to 10 wt % based on the total weight of the soil amendment composition. In one embodiment, the humic acid is present at 4 wt % to 10 wt % based on the total weight of the soil amendment composition. In one embodiment, the humic acid is present at 5 wt % to 10 wt % based on the total weight of the soil amendment composition. In one embodiment, the humic acid is present at 0.5 wt % to 5 wt % based on the total weight of the soil amendment composition. In one embodiment, the humic acid is present at 1 wt % to 5 wt % based on the total weight of the soil amendment composition. In one embodiment, the humic acid is present at 2 wt % to 5 wt % based on the total weight of the soil amendment composition. In one embodiment, the humic acid is present at 3 wt % to 5 wt % based on the total weight of the soil amendment composition. In one embodiment, the humic acid is present at 4 wt % to 5 wt % based on the total weight of the soil amendment composition. In one embodiment, the humic acid is present at 0.5 wt % to 4 wt % based on the total weight of the soil amendment composition. In one embodiment, the humic acid is present at 1 wt % to 4 wt % based on the total weight of the soil amendment composition. In one embodiment, the humic acid is present at 2 wt % to 4 wt % based on the total weight of the soil amendment composition. In one embodiment, the humic acid is present at 3 wt % to 4 wt % based on the total weight of the soil amendment composition. In one embodiment, the humic acid is present at 0.5 wt % to 3 wt % based on the total weight of the soil amendment composition. In one embodiment, the humic acid is present at 1 wt % to 3 wt % based on the total weight of the soil amendment composition. In one embodiment, the humic acid is present at 2 wt % to 3 wt % based on the total weight of the soil amendment composition. In one embodiment, the humic acid is present at 0.5 wt % to 2 wt % based on the total weight of the soil amendment composition. In one embodiment, the humic acid is present at 1 wt % to 2 wt % based on the total weight of the soil amendment composition. In one embodiment, the humic acid is present at 0.5 wt % to 1 wt % based on the total weight of the soil amendment composition.

In one embodiment, the soil amendment composition is substantially free of a microbial component. As used herein, “substantially free of a microbial component” in a composition refers to less than about 1 wt % of a microbial component based on the total weight of the composition.

In one embodiment, the at least one of basalt, metabasalt, diabase, andesite, meta-andesite, phyllite, rhyolite, or a combination thereof is in the form of a plurality of particles (referred herein as “rock fines”), with at least about 20% of the rock fines passing 100 US Mesh. In another embodiment, at least about 20% of the rock fines pass 100 US Mesh and the balance pass 200 US Mesh. In one embodiment, the at least one of basalt, metabasalt, diabase, andesite, meta-andesite, phyllite, rhyolite, or a combination thereof is in the form of a plurality of particles (referred herein as “rock fines”), with at least about 30% of the rock fines passing 100 US Mesh. In another embodiment, at least about 30% of the rock fines pass 100 US Mesh and the balance pass 200 US Mesh. In one embodiment, the at least one of basalt, metabasalt, diabase, andesite, meta-andesite, phyllite, rhyolite, or a combination thereof is in the form of a plurality of particles (referred herein as “rock fines”), with at least about 40% of the rock fines passing 100 US Mesh. In another embodiment, at least about 40% of the rock fines pass 100 US Mesh and the balance pass 200 US Mesh. In one embodiment, the at least one of basalt, metabasalt, diabase, andesite, meta-andesite, phyllite, rhyolite, or a combination thereof is in the form of a plurality of particles (referred herein as “rock fines”), with at least about 50% of the rock fines passing 100 US Mesh. In another embodiment, at least about 50% of the rock fines pass 100 US Mesh and the balance pass 200 US Mesh. In one embodiment, the at least one of basalt, metabasalt, diabase, andesite, meta-andesite, phyllite, rhyolite, or a combination thereof is in the form of a plurality of particles (referred herein as “rock fines”), with at least about 60% of the rock fines passing 100 US Mesh. In another embodiment, at least about 60% of the rock fines pass 100 US Mesh and the balance pass 200 US Mesh. In one embodiment, the at least one of basalt, metabasalt, diabase, andesite, meta-andesite, phyllite, rhyolite, or a combination thereof is in the form of a plurality of particles (referred herein as “rock fines”), with at least about 70% of the rock fines passing 100 US Mesh. In another embodiment, at least about 70% of the rock fines pass 100 US Mesh and the balance pass 200 US Mesh. In one embodiment, the at least one of basalt, metabasalt, diabase, andesite, meta-andesite, phyllite, rhyolite, or a combination thereof is in the form of a plurality of particles (referred herein as “rock fines”), with at least about 80% of the rock fines passing 100 US Mesh. In another embodiment, at least about 80% of the rock fines pass 100 US Mesh and the balance pass 200 US Mesh. In one embodiment, the at least one of basalt, metabasalt, diabase, andesite, meta-andesite, phyllite, rhyolite, or a combination thereof is in the form of a plurality of particles (referred herein as “rock fines”), with at least about 90% of the rock fines passing 100 US Mesh. In another embodiment, at least about 90% of the rock fines pass 100 US Mesh and the balance pass 200 US Mesh.

In one embodiment, the at least one of basalt, metabasalt, diabase, andesite, meta-andesite, phyllite, rhyolite, or a combination thereof is in the form of a plurality of particles (referred herein as “rock fines”) that are of such a particle size as to pass US Mesh 40. In other embodiments, the rock fines are of such a particle size as to pass US Mesh 50, or US Mesh 60, or US Mesh 70, or US Mesh 100, or US Mesh 120, or US Mesh 140, or US Mesh 200, or US Mesh 230, or US Mesh 270, or US Mesh 325. Ranges based on any of the foregoing are also contemplated, e.g., the rock and/or mineral fragments may have particle sizes passing US Mesh 40 but retained by US Mesh 270.

Each particle can have the shape of a sphere, a cube, a rectangular prism, a cylinder, a cone, or a cuboid. In some embodiments, the particles are spherical. Each particle can be characterized by having a largest dimension. In one embodiment, the plurality of particles have an average particle size of about 0.25 mm to about 10 mm. In one embodiment, the plurality of particles have an average particle size of about 0.5 mm to about 10 mm. In one embodiment, the plurality of particles have an average particle size of about 1 mm to about 10 mm. In one embodiment, the plurality of particles have an average particle size of about 2 mm to about 10 mm. In one embodiment, the plurality of particles have an average particle size of about 3 mm to about 10 mm. In one embodiment, the plurality of particles have an average particle size of about 4 mm to about 10 mm. In one embodiment, the plurality of particles have an average particle size of about 5 mm to about 10 mm. In one embodiment, the plurality of particles have an average particle size of about 6 mm to about 10 mm. In one embodiment, the plurality of particles have an average particle size of about 7 mm to about 10 mm. In one embodiment, the plurality of particles have an average particle size of about 8 mm to about 10 mm. In one embodiment, the plurality of particles have an average particle size of about 9 mm to about 10 mm. In one embodiment, the plurality of particles have an average particle size of about 0.25 mm to about 9 mm. In one embodiment, the plurality of particles have an average particle size of about 0.5 mm to about 9 mm. In one embodiment, the plurality of particles have an average particle size of about 1 mm to about 9 mm. In one embodiment, the plurality of particles have an average particle size of about 2 mm to about 9 mm. In one embodiment, the plurality of particles have an average particle size of about 3 mm to about 9 mm. In one embodiment, the plurality of particles have an average particle size of about 4 mm to about 9 mm. In one embodiment, the plurality of particles have an average particle size of about 5 mm to about 9 mm. In one embodiment, the plurality of particles have an average particle size of about 6 mm to about 9 mm. In one embodiment, the plurality of particles have an average particle size of about 7 mm to about 9 mm. In one embodiment, the plurality of particles have an average particle size of about 8 mm to about 9 mm. In one embodiment, the plurality of particles have an average particle size of about 0.25 mm to about 8 mm. In one embodiment, the plurality of particles have an average particle size of about 0.5 mm to about 8 mm. In one embodiment, the plurality of particles have an average particle size of about 1 mm to about 8 mm. In one embodiment, the plurality of particles have an average particle size of about 2 mm to about 8 mm. In one embodiment, the plurality of particles have an average particle size of about 3 mm to about 8 mm. In one embodiment, the plurality of particles have an average particle size of about 4 mm to about 8 mm. In one embodiment, the plurality of particles have an average particle size of about 5 mm to about 8 mm. In one embodiment, the plurality of particles have an average particle size of about 6 mm to about 8 mm. In one embodiment, the plurality of particles have an average particle size of about 7 mm to about 8 mm. In one embodiment, the plurality of particles have an average particle size of about 0.25 mm to about 7 mm. In one embodiment, the plurality of particles have an average particle size of about 0.5 mm to about 7 mm. In one embodiment, the plurality of particles have an average particle size of about 1 mm to about 7 mm. In one embodiment, the plurality of particles have an average particle size of about 2 mm to about 7 mm. In one embodiment, the plurality of particles have an average particle size of about 3 mm to about 7 mm. In one embodiment, the plurality of particles have an average particle size of about 4 mm to about 7 mm. In one embodiment, the plurality of particles have an average particle size of about 5 mm to about 7 mm. In one embodiment, the plurality of particles have an average particle size of about 6 mm to about 7 mm. In one embodiment, the plurality of particles have an average particle size of about 0.25 mm to about 6 mm. In one embodiment, the plurality of particles have an average particle size of about 0.5 mm to about 6 mm. In one embodiment, the plurality of particles have an average particle size of about 1 mm to about 6 mm. In one embodiment, the plurality of particles have an average particle size of about 2 mm to about 6 mm. In one embodiment, the plurality of particles have an average particle size of about 3 mm to about 6 mm. In one embodiment, the plurality of particles have an average particle size of about 4 mm to about 6 mm. In one embodiment, the plurality of particles have an average particle size of about 5 mm to about 6 mm. In one embodiment, the plurality of particles have an average particle size of about 0.25 mm to about 5 mm. In one embodiment, the plurality of particles have an average particle size of about 0.5 mm to about 5 mm. In one embodiment, the plurality of particles have an average particle size of about 1 mm to about 5 mm. In one embodiment, the plurality of particles have an average particle size of about 2 mm to about 5 mm. In one embodiment, the plurality of particles have an average particle size of about 3 mm to about 5 mm. In one embodiment, the plurality of particles have an average particle size of about 4 mm to about 5 mm. In one embodiment, the plurality of particles have an average particle size of about 0.25 mm to about 4 mm. In one embodiment, the plurality of particles have an average particle size of about 0.5 mm to about 4 mm. In one embodiment, the plurality of particles have an average particle size of about 1 mm to about 4 mm. In one embodiment, the plurality of particles have an average particle size of about 2 mm to about 4 mm. In one embodiment, the plurality of particles have an average particle size of about 3 mm to about 4 mm. In one embodiment, the plurality of particles have an average particle size of about 0.25 mm to about 3 mm. In one embodiment, the plurality of particles have an average particle size of about 0.5 mm to about 3 mm. In one embodiment, the plurality of particles have an average particle size of about 1 mm to about 3 mm. In another embodiment, the plurality of particles have an average particle size about 2 mm to about 3 mm. In one embodiment, the plurality of particles have an average particle size of about 0.25 mm to about 2 mm. In one embodiment, the plurality of particles have an average particle size of about 0.5 mm to about 2 mm. In one embodiment, the plurality of particles have an average particle size of about 1 mm to about 2 mm. In one embodiment, the plurality of particles have an average particle size of about 0.25 mm to about 1 mm. In one embodiment, the plurality of particles have an average particle size of about 0.5 mm to about 1 mm. In one embodiment, the plurality of particles have an average particle size of about 0.25 mm to about 0.5 mm.

In some embodiments, the plurality of particles can be substantially uniform in size. In some embodiments, the plurality of particles are substantially uniform in size when the largest dimensions of all the particles do not vary by more than 10%.

Another embodiment of this invention pertains to a method comprising: (a) mixing (i) at least one of basalt, metabasalt, diabase, andesite, meta-andesite, phyllite, rhyolite, or a combination thereof, (ii) an organic portion, and (iii) a binder to produce a plurality of particles; (b) heating the plurality of particles; and (c) separating particles from the plurality of particles in accordance with size to obtain a soil amendment composition, wherein the at least one of basalt, metabasalt, diabase, andesite, meta-andesite, phyllite, rhyolite, or a combination thereof is present at 30 wt % to 70 wt % based on a total weight of the soil amendment composition, and wherein the organic portion is present at 20 wt % to 65 wt % based on the total weight of the soil amendment composition.

In one embodiment, the mixing uses a pin mixer.

In one embodiment, the method further comprises pelletizing the soil amendment composition. In another embodiment, the pelletizing uses at least one of a disk pelletizer or a pan pelletizer.

In one embodiment, the heating includes exposing the plurality of particles to a temperature of 38° C. to 150° C., e.g., between about 40° C. and about 150° C., between about 50° C. and about 150° C., between about 60° C. and about 150° C., between about 70° C. and about 150° C., between about 80° C. and about 150° C., between about 90° C. and about 150° C., between about 100° C. and about 150° C., between about 40° C. and about 120° C., or between about 40° C. and about 100° C. For the compositions that are substantially free of a microbial component, higher temperatures in the heating step can be used.

In one embodiment, the mixing further includes mixing humic acid with (i) the at least one of basalt, metabasalt, diabase, andesite, meta-andesite, phyllite, rhyolite, or a combination thereof, (ii) the organic portion, and (iii) the binder to produce a plurality of particles.

In some embodiments, equipment that can be used in the manufacturing process includes, but is not limited to, a dry mixing bin, a liquid binder storage tank, a pin mixer, a disk pelletizer, a dryer (rotary or fluidized bed), a screener, a crusher, and bagging equipment.

The compositions of the present disclosure can be used in agriculture, horticulture, and gardening. The compositions can be used to condition the soil and/or improve soil quality. The compositions can be applied effectively by using standard agricultural equipment, e.g., a manual or powered spin-broadcast fertilizer spreader, a seed, or a hydroseeder. The compositions can be applied in one or more plant growing seasons.

In some embodiments, the above-described organo-mineral combinations or compositions can be used for carbon sequestration (or carbon capture).

The fine particle size of the particles allows for spray application. In some embodiments, the soil amendment composition can be suspended in a liquid and then sprayed onto the soil. For example, the liquid with the suspended particles can be sprayed onto the soil through a motor vehicle or an aircraft.

Prior to applying the compositions of the present disclosure, the soil can be tested to determine what it needs in terms of pH, macro and micronutrients as to produce healthy plants and/or optimizing crop yield. Based on the test results, a composition with the appropriate mineral/organic material ratio can then be applied to the soil.

According to one embodiment of the present invention, an organo-mineral fertilizer or soil amendment is developed using rock fines in combination with plant and/or animal derived products. With the increasing demand for fertilizers worldwide and constraining supply chain, there is a need to find alternative fertilizers for sustainable crop products. The fertilizer or soil amendment of the present disclosure uses plant and/or animal byproducts in combination with rock fines to make a new type of organo-mineral fertilizer or soil amendment.

Most of the commercially available fertilizers are highly soluble in water and prone to loss via surface runoff and leaching. These fertilizers provide nutrient immediately to the plants but are lost from the soil during later plant growth stages. According to one embodiment, the organo-mineral fertilizer or soil amendment of the present disclosure is a slow release fertilizer and provides nutrients to plants throughout their life cycle and other successive crops. In addition to mineral components, the organo-mineral fertilizer or soil amendment of the present disclosure provides organic matter that improves overall soil structure, cation exchange capacity, and water holding capacity.

As discussed, the increasing demand for food supply to feed the growing population has led people to look into alternative fertilizer sources. Various byproducts from production, such as, e.g., coffee chaff or food waste, if not recycled properly, will end up in the landfill sites. These materials, which are either plant derived or animal derived, provide some nutritional value and could be used as an alternative fertilizer source for plant nutritional needs. When in combination with rock fines (e.g., basalt, metabasalt, diabase, andesite, meta-andesite, phyllite, rhyolite, or a combination thereof), this organic waste could provide a complete nutritional package for plant growth. These organo-mineral fertilizers or soil amendments not only provide plant nutrients but also have beneficial effects on soil characteristics, such as, e.g., improving organic matter content, cation exchange capacity, aeration, drainage, decreasing compaction by overall decreasing bulk density, improving water holding capacity, and enhancing microbial activity. In some cases, the organo-mineral fertilizer or soil amendment mixture could be used solely as a plant growth medium and/or a potting mix.

### EXAMPLES

Specific embodiments of the invention will now be demonstrated by reference to the following examples. It should be understood that these examples are disclosed by way of illustrating the invention and should not be taken in any way to limit the scope of the invention.

### Example 1

Exemplary components and ranges for an embodiment of the organo-mineral fertilizer or soil amendment is given in Table 1.

TABLE 1

| Components | Preferred Range (wt %) | Broader Range (wt %) |
|---|---|---|
| Metabasalt | 30-60 | 1-99 |
| Coffee Chaff | 25-50 | 1-99 |
| Food Waste | 25-50 | 1-99 |
| Humic Acid | 0.5-5 | 0.5-25 |
| Binder | 2-5 | 0.5-10 |

### Example 2

Exemplary formulations for a pelletized product (e.g., an organo-mineral fertilizer or soil amendment) are given in Table 2.

TABLE 2

| | | Coffee | Food | Humic | | |
|---|---|---|---|---|---|---|
| Examples | Metabasalt | Chaff | Waste | Acid | Binder | Total |
| 1 | 30 | 65 | — | 1 | 4 | 100 |
| 2 | 54 | 40 | — | 2 | 4 | 100 |
| 3 | 74 | 20 | — | 2 | 4 | 100 |
| 4 | 54 | 40 | — | 2 | 4 | 100 |
| 5 | 64 | 30 | — | 2 | 4 | 100 |
| 6 | 50 | 24 | 20 | 2 | 4 | 100 |
| 7 | 50 | 24 | 22 | 0 | 4 | 100 |

### Example 3

Exemplary formulations for a bulk mix, a potting mix, and/or a turf mix are given in Tables 3A and 3B.

TABLE 3A

| | | Coconut | | |
|---|---|---|---|---|
| | Metabasalt | Coir/Peat Moss | Compost | Total |
| Examples | (Vol. %) | (Vol. %) | (Vol. %) | (Vol. %) |
| 1 | 50 | 20 | 30 | 100 |
| 2 | 70 | 10 | 20 | 100 |
| 3 | 50 | 0 | 50 | 100 |
| 4 | 25 | 25 | 50 | 100 |
| 5 | 5 | 30 | 65 | 100 |

TABLE 3B

| | Peat Moss | Metabasalt | Total |
|---|---|---|---|
| Examples | (Vol. %) | (Vol. %) | (Vol. %) |
| 1 | 99 | 1 | 100 |
| 2 | 98 | 2 | 100 |
| 3 | 95 | 5 | 100 |
| 4 | 90 | 10 | 100 |
| 5 | 85 | 15 | 100 |
| 6 | 80 | 20 | 100 |
| 7 | 70 | 30 | 100 |
| 8 | 50 | 50 | 100 |
| 9 | 25 | 75 | 100 |
| 10 | 10 | 90 | 100 |
| 11 | 1 | 99 | 100 |

### Example 4

Exemplary formulations for a pelletized product (e.g., an organo-mineral fertilizer or soil amendment) are given in Table 4.

TABLE 4

| | | % Rock/Mineral | % Binder Solids |
|---|---|---|---|
| Examples | % Coffee Chaff | (Rock/Mineral Fines) | (Molasses) |
| 1 | 29% | 57.5% | 14% |
| 2 | 29% | 58.5% | 12% |
| 3 | 30% | 61% | 9% |
| 4 | 31% | 62% | 7% |
| 5 | 31% | 62% | 6.5% |
| 6 | 32% | 63.5% | 5% |
| 7 | 21% | 70% | 8.5% |
| 8 | 29% | 58% | 13% |
| 9 | 37% | 49% | 15% |

According to some embodiments, the metabasalt could be in powder form or coarser grades (e.g., 0.05 to 10 mm).

As discussed above, one example of rock and/or mineral (e.g., “rock or mineral fines”) is basalt; however, metabasalt (which is an amphibolite produced from the metamorphism of the basalt parent) may be used in addition to or instead of basalt. In other words, where the embodiments use the term basalt, they should be read as describing the use of basalt, metabasalt, or a combination of basalt and metabasalt.

Although the invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. A soil amendment composition comprising:
(a) at least one of basalt, metabasalt, diabase, andesite, meta-andesite, phyllite, rhyolite, or a combination thereof, wherein the at least one of basalt, metabasalt, diabase, andesite, meta-andesite, phyllite, rhyolite, or a combination thereof is present at 30 wt % to 70 wt % based on a total weight of the soil amendment composition;
(b) an organic portion that is present at 20 wt % to 65 wt % based on the total weight of the soil amendment composition; and
(c) a binder,
wherein the soil amendment composition is in the form of a plurality of particles.

2. The soil amendment composition according to claim 1, wherein the soil amendment composition comprises basalt.

3. The soil amendment composition according to claim 1, wherein the soil amendment composition comprises metabasalt.

4. The soil amendment composition according to claim 1, wherein the organic portion comprises at least one of coffee chaff, rice husk, animal manure, turkey/poultry litter, animal bedding, food derived waste, agricultural waste, saw dust, wood chips, peat moss, coconut coir, bagasse, compost, biochar, sewage sludge, blood meal, bone meal, fish meal, feather meal, corn steep dry, soy protein hydrolysates, coffee grinds, food or animal derived digestate, or a combination thereof.

5. The soil amendment composition according to claim 1, wherein the organic portion comprises coffee chaff, food derived waste, or a combination thereof.

6. The soil amendment composition according to claim 1, wherein the organic portion is present at 40 wt % to 65 wt % based on the total weight of the soil amendment composition.

7. The soil amendment composition according to claim 1, wherein the binder is present at 0.5 wt % to 20 wt % based on the total weight of the soil amendment composition.

8. The soil amendment composition according to claim 1, wherein the binder is molasses, lignosulfonate, clay, or a combination thereof.

9. The soil amendment composition according to claim 1, wherein the soil amendment composition further comprises humic acid.

10. The soil amendment composition according to claim 9, wherein the humic acid is present at 0.5 wt % to 25 wt % based on the total weight of the soil amendment composition.

11. The soil amendment composition according to claim 1, wherein the soil amendment composition is substantially free of a microbial component.

12. The soil amendment composition according to claim 1, wherein the at least one of basalt, metabasalt, diabase, andesite, meta-andesite, phyllite, rhyolite, or a combination thereof is in the form of a plurality of particles (referred herein as “rock fines”), with at least about 60% of the rock fines passing 100 US Mesh.

13. The soil amendment composition according to claim 1, wherein the at least one of basalt, metabasalt, diabase, andesite, meta-andesite, phyllite, rhyolite, or a combination thereof is in the form of a plurality of particles that are of such a particle size as to pass US Mesh 40.

14. The soil amendment composition according to claim 1, wherein the plurality of particles have an average particle size of about 0.25 mm to about 10 mm.

15. A method comprising:
(a) mixing (i) at least one of basalt, metabasalt, diabase, andesite, meta-andesite, phyllite, rhyolite, or a combination thereof, (ii) an organic portion, and (iii) a binder to produce a plurality of particles;
(b) heating the plurality of particles; and
(c) separating particles from the plurality of particles in accordance with size to obtain a soil amendment composition,
wherein the at least one of basalt, metabasalt, diabase, andesite, meta-andesite, phyllite, rhyolite, or a combination thereof is present at 30 wt % to 70 wt % based on a total weight of the soil amendment composition, and
wherein the organic portion is present at 20 wt % to 65 wt % based on the total weight of the soil amendment composition.

16. The method according to claim 15, wherein the mixing uses a pin mixer.

17. The method according to claim 15, wherein the method further comprises pelletizing the soil amendment composition.

18. The method according to claim 15, wherein the heating includes exposing the plurality of particles to a temperature of 38° C. to 150° C.

19. The method according to claim 15, wherein the organic portion comprises at least one of coffee chaff, rice husk, animal manure, turkey/poultry litter, animal bedding, food derived waste, agricultural waste, saw dust, wood chips, peat moss, coconut coir, bagasse, compost, biochar, sewage sludge, blood meal, bone meal, fish meal, feather meal, corn steep dry, soy protein hydrolysates, coffee grinds, food or animal derived digestate, or a combination thereof.

20. The method according to claim 15, wherein the binder is present at 0.5 wt % to 20 wt % based on the total weight of the soil amendment composition.

21. The method according to claim 15, wherein the binder is molasses, lignosulfonate, clay, or a combination thereof.

22. The method according to claim 15, wherein the mixing further includes mixing humic acid with (i) the at least one of basalt, metabasalt, diabase, andesite, meta-andesite, phyllite, rhyolite, or a combination thereof, (ii) the organic portion, and (iii) the binder to produce a plurality of particles.

23. The method according to claim 22, wherein the humic acid is present at 0.5 wt % to 25 wt % based on the total weight of the soil amendment composition.
